(19) United States
(12) Patent Application Publication
(10) Pub. No.: US 2011/0252163 A1
(43) Pub. Date: Oct. 13, 2011

(54) Integrated Development Environment for Rapid Device Development

(75) Inventors: Nicolas Villar, Cambridge (GB); James Scott, Cambridge (GB); Stephen Hodges, Cambridge (GB); David Alexander Butler, Cambridge (GB); Shahram Izadi, Girton (GB)

(73) Assignee: Microsoft Corporation, Redmond, WA (US)

(21) Appl. No.: 12/757,758

(22) Filed: Apr. 9, 2010

(51) Int. Cl. G06F 3/00; G06F 13/10

(52) U.S. Cl. 710/16; 703/20; 715/848; 715/773

(57) ABSTRACT

An integrated development environment for rapid device development is described. In an embodiment the integrated development environment provides a number of different views to a user which each relate to a different aspect of device design, such as hardware configuration, software development and physical design. The device, which may be a prototype device, is formed from a number of objects which are selected from a database and the database stores multiple data types for each object, such as a 3D model, software libraries and code-stubs for the object and hardware parameters. A user can design the device by selecting different views in any order and can switch between views as they choose. Changes which are made in one view, such as the selection of a new object, are fed into the other views.

### BACKGROUND

Realization of prototype devices is a key part of the process to develop new computing devices and currently this process is both time-consuming and expensive. Prototypes may be used for laboratory testing and/or for user trials and this means that the prototypes often need to be sufficiently representative of the final product in terms of size, weight, performance etc, which compounds the difficulties in producing suitable prototypes rapidly. Where a representative prototype can be produced, trials of consumer computing devices with end-users can be performed at an early stage in the development process and this can provide useful information about the value of the device, whether it warrants further development and what changes might make it more useful, more user friendly etc.

In order to develop a representative prototype it is often necessary to perform virtually the same steps as for creating the final product, e.g. designing a PCB and having it made, developing the firmware to run on the device, designing a casing and having it fabricated and then assembling the device. This leads to large upfront costs and is very time-consuming and expensive to iterate.

The embodiments described below are not limited to implementations which solve any or all of the disadvantages of known prototyping or development methods and tools.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An integrated development environment for rapid device development is described. In an embodiment the integrated development environment provides a number of different views to a user which each relate to a different aspect of device design, such as hardware configuration, software development and physical design. The device, which may be a prototype device, is formed from a number of objects which are selected from a database and the database stores multiple data types for each object, such as a 3D model, software libraries and code-stubs for the object and hardware parameters. A user can design the device by selecting different views in any order and can switch between views as they choose. Changes which are made in one view, such as the selection of a new object, are fed into the other views.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an integrated development environment for rapid development of devices;

FIG. 2 shows a flow diagram of an example method of operation of the constraint resolver;

FIG. 3 is a schematic diagram showing an alternative representation of the integrated development environment shown in FIG. 1;

FIG. 4 comprises two flow diagrams which show example methods of operation of the hardware configuration engine and the software development engine;

FIG. 5 is a flow diagram showing an example method of operation of the physical design engine;

FIGS. 6, 8, 9 and 11 are schematic diagrams of further examples of integrated development environments for rapid development of devices;

FIG. 7 shows a flow diagram of an example method of operation of the simulation engine;

FIGS. 10 and 12 show flow diagrams of example methods of operation of the synchronization element; and

FIG. 13 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

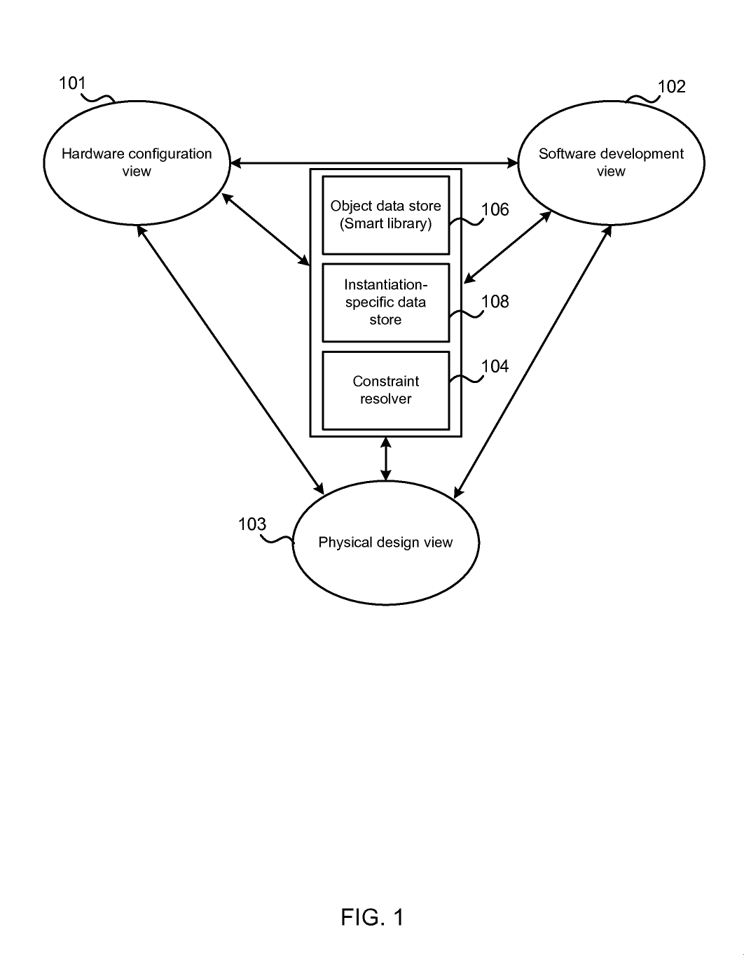

FIG. 1 is a schematic diagram of an integrated development environment (IDE) for rapid development of devices, where the device includes a physical casing and some internal component modules, such as electronic parts or sensors, which execute some pre-programmed software. In an example, the IDE may be used to rapidly prototype devices and any reference to development of a prototype device in the following description is by way of example only. The IDE provides a user with a number of different views 101-103 within a single development environment which each enable a user to develop a different aspect of a device. These views are described in more detail below. A user may select these views in any order when developing a device and may switch between views when they choose and as such the IDE provides a flexible non-linear approach to device design. The views are linked by an element which provides synchronization between views such that a change made to a design by a user in one view is reflected in the other views. In this example, the element is a constraint resolver 104.

Each of the views has access to an object data store 106 (which may also be referred to as a smart library) and an instantiation-specific data store 108. The object data store 106 stores instantiation-independent data about objects or classes of object which may be used to build up a device and the instantiation-specific data store 108 stores data which is specific to the device being created, such as parameters which may be user-specified or inferred. The term ‘inferred parameters’ is used herein to refer to any parameter which is generated by the IDE (e.g. within any view of the IDE). These parameters may be generated as a result of user input (e.g. the combination of objects selected, the particular code written etc). It will be appreciated that an object may comprise a grouped cluster of other objects. In many embodiments, the IDE only reads data from the object data store 106 but reads and writes data from and to the instantiation-specific data store 108.

The hardware configuration view 101 displays details of objects (or classes of object) that are available and allows a user to select objects (or classes of object) from the object data store 106 to form a device. For example, a user may select a memory module, a processor, a display, a battery, a user input device (such as a keypad), a GPRS (general packet radio service) module etc. A user input device provides an example of a class of object because there may be many different types of user input devices (the objects) that may be selected. In another example, there may be many different displays that the user can select (which are each different objects) and which form a class of objects ‘displays’. In a third example, a user may select the class of objects ‘battery’, which is equivalent to the user saying “use any battery”, or may select a particular battery, which is equivalent to the user saying “use this particular battery” (e.g. a battery having a particular capacity or a particular type of battery). In the following description, any reference to an object is by way of example only and may also refer to a class of objects.

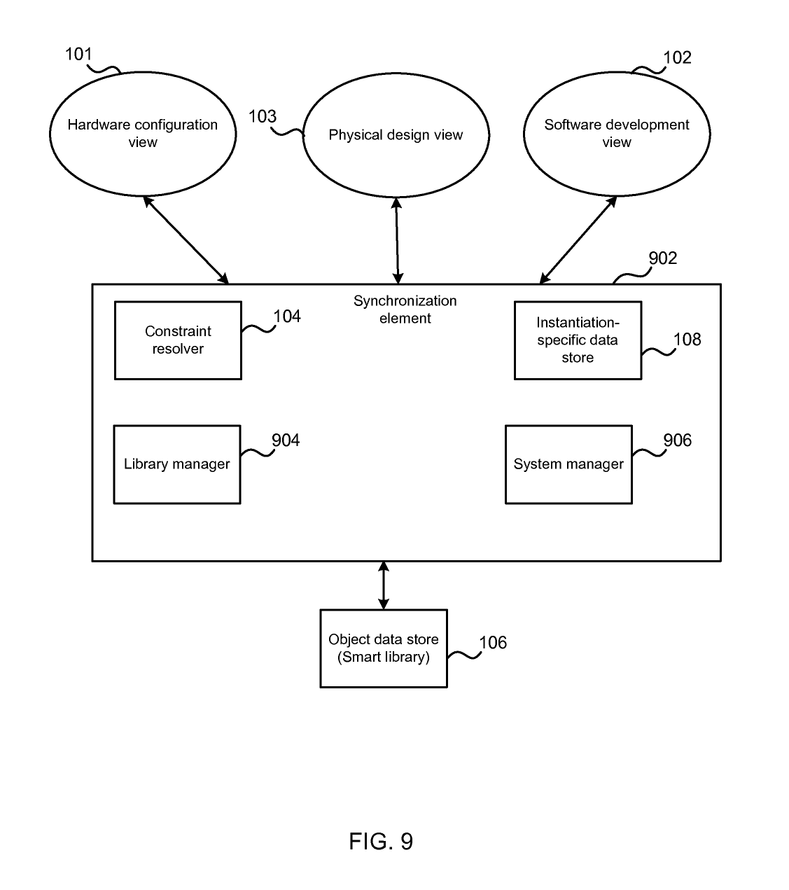

The hardware configuration view 101 also allows a user to configure object parameters, for example, a user may select a class of objects ‘displays’ and configure the object parameters to specify the minimum display size, display resolution etc. This may, in some examples, be equivalent to selecting a subset of a class, e.g. all displays in the class ‘display’ which have a size which exceeds the user-specified parameter. Any object parameters which have been configured are stored in the instantiation-specific data store 108 (this information is instantiation-specific because it relates to a particular device build). Details of the objects selected may also be stored in the instantiation-specific data store 108 or may be recorded in another way (e.g. through loading of appropriate object data from the object data store 106 into a central repository, as described in more detail below with reference to FIGS. 9-12).

The list of available objects, which is provided to the user to enable them to make a selection, (and which may be provided to the user in any form, not necessarily list form), may comprise all the objects which are in the object data store 106. However, this list of available objects may be updated based on selections which have already been made (e.g. to take account of incompatibilities between objects or any constraints specified, as described in more detail below), based on instantiation-specific parameters which are stored in the instantiation-specific data store 108 (and may have been generated in other views) and/or dependent on other factors. An automatic decision-making algorithm may be used to generate the list of available objects.

In an embodiment, the objects which may be used to create the device may comprise a set of modular hardware elements which have been designed for rapid prototyping of devices or for rapid development of non-prototype devices. The set may, for example, comprise a core module which comprises a main processor and to which a number of other electronic modules can be easily connected. In an example, each electronic module may be fitted with a flying lead and compatible connector. Power may be provided via the core module to each peripheral module, or the peripheral modules may each comprise a battery or a connection to a power supply (e.g. via USB). The peripheral modules may, for example, provide additional capabilities (over those provided on the core module) for input, output, communications, power, display, sensing and actuation. In some examples, a common communication protocol may be used but in other examples, different communication protocols may be used between the core module and different peripheral modules.

The software development view 102 enables a user to write computer code to run on the device and provides a front-end to a compiler and access to debugging tools and an emulator. The IDE may be based on the Microsoft .NET Micro Framework which allows the devices (which may be small and resource constrained) to be programmed with C# and make use of high-level programming primitives provided by the .Net Micro Framework libraries or other high-level libraries. The software development view 102 automates the process of configuring and using individual objects (which may, in an embodiment, comprise modules selected from the set of modular hardware elements). Any libraries and code-stubs which are used by objects selected in the hardware configuration view 101 (or other views) are automatically loaded from the object data store 106. When software is compiled, a number of inferred parameters associated with the device are generated, such as the amount of memory required to store the code and the amount of memory required to execute the code. These inferred parameters are stored in the instantiation-specific data store 108. Another example of an inferred parameter which may be generated by the software development view 102 is the expected battery life (dependent upon the battery selected by the user).

The physical design view 103 displays a 3D (three-dimensional) representation of the device (based on the objects selected), which may include a representation of the casing for the device. The initial 3D representation (e.g. which is displayed before any user input in this view) and the casing may be automatically generated within the IDE. The physical design view allows a user to manipulate this 3D representation to view it from any perspective and to rearrange the selected objects in space. The physical design view also allows a user to specify configuration parameters for the device (e.g. overall size constraints or other physical design rules) and for individual objects (e.g. the display must be located on an identified face of the device or must be located on the same face as particular user input modules, e.g. a keypad). These configuration parameters, which may be referred to as ‘global parameters’ where they relate to the overall device and not to a particular object within the device, are stored in the instantiation-specific data store 108 along with any inferred parameters which are generated by the physical design view, such as an overall size and shape of the device, the shape of the automatically generated case etc. Where any physical design rules are violated (e.g. the selected objects cannot be fitted within a user-specified maximum dimension for the device), the physical design view may provide a visualization of this to the user, e.g. by highlighting parts of the 3D representation or displaying a message to the user.

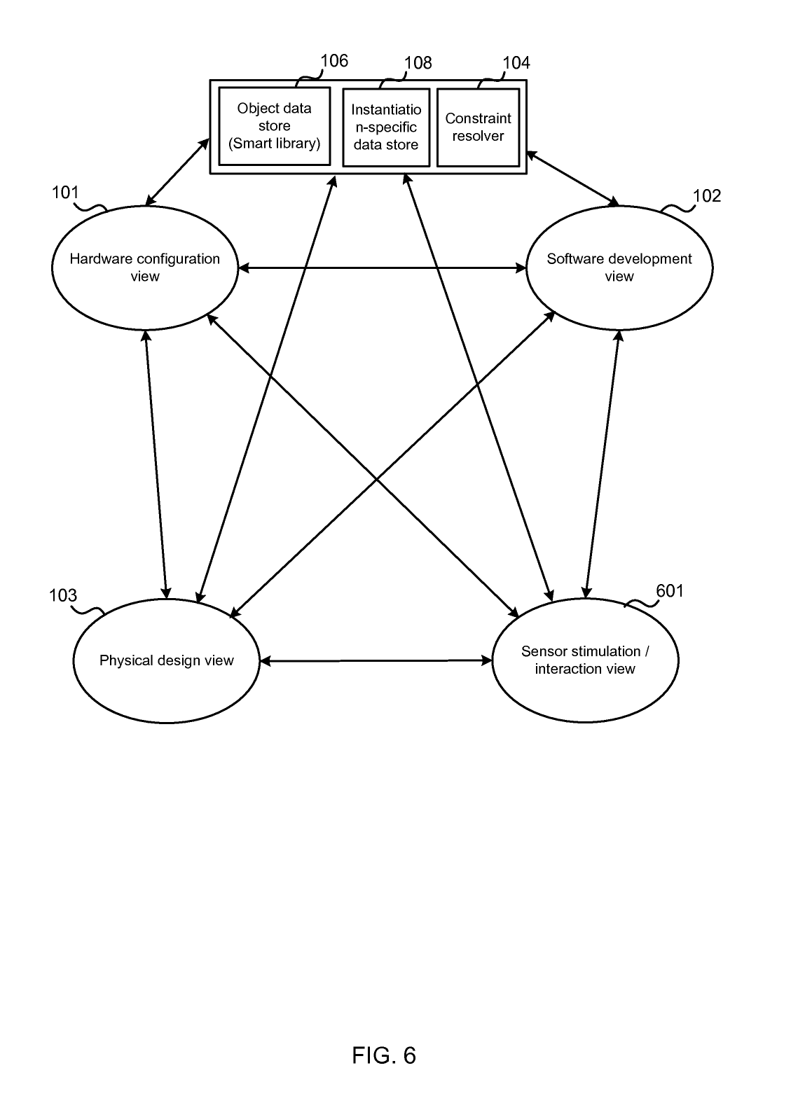

The object data store 106 stores instantiation-independent data about the different objects, or classes of object, which can be assembled to form a device and a plurality of different types of data are stored associated with each object or class of object. The different types of data which are stored associated with a particular object may correspond to the different views which are provided within the IDE, for example:
a 3D model (which corresponds to the physical design view 103);
details of any software libraries or code-stubs used by the object (which correspond to the software development view 102), where the particular library/code-stub may be stored associated with the object or a reference to the particular library/code-stub may be stored; and
hardware parameters (which correspond to the hardware configuration view 101), such as one or more of:
   the electrical connections required (e.g. ground, 5V, UART)
   any optional electrical connections (e.g. if pin X is connected, the additional capability of module reset is enabled)
   any hardware choices (e.g. an object can support either a UART or I2C interface and one of these is required)
   details of whether an electrical line is a multi-drop line (e.g. UART) or point-to-point connection (e.g. I2C)
   functionality
   connectors that can be used and sockets that they can be plugged into
   external connectors
   wiring compatibility
   details of any parameters which are user-configurable.
      Additional data may also be stored associated with an object such as:
constraints (e.g. incompatibilities with other objects or different methods which are enabled dependent upon which connections are made to an object), which may be defined in terms of a rule set for the object;
mounting issues, such as details relating to positioning the object on a particular face of the device, positioning relative to other objects or the casing, orientation sensitivity (e.g. some devices may have a ‘top’ and a ‘bottom’ which must be respected when designing a prototype) etc and how to adjust to accommodate these issues automatically;
mounting details, such as the position of mounting holes/brackets etc;
mechanical strength;
performance data, such as power consumption (and this may comprise different power consumption values for different modes, e.g. awake or asleep), time taken to wake-up if asleep, time to take a reading (for sensors), thermal tolerances, unit conversion (e.g. a temperature sensor may output 12 bits which is mapped to ° C. using a conversion formula), etc;
sensor stimuli data (as described in more detail below with reference to the embodiment of FIG. 6);
details of variables associated with the object which have instantiation-specific values (e.g. which may be user-specified or generated within the IDE) and where the values may not be specified or may be set to an initial default value, these variables are referred to herein as ‘object variables’;
any other data (not already specified above) which is required to simulate the object;
data sheets; and
purchasing information, such as part numbers, costs, manufacturer and distributor details, inventory in local part stores, etc.
   This additional data may correspond to one of the particular views or may relate to one or more views.

The rules defined for a particular object may be defined in algebraic form, e.g. (A+B+C)<Y where A, B, C and Y are object variables or inferred parameters, such as voltages, currents, capacities, consumptions, bandwidth etc. The rules may themselves add extra constraints, e.g. if Z is true, then A<Y.

The data associated with a particular object (or class of object) may be stored in modular form, such that when a new object is developed or otherwise become available for selection by a user to include within a device being developed using the IDE, the modular data associated with the new object can be added easily to the object data store 106. For example, the instantiation-independent data for an object (or class of objects) may be included within a ‘module description’, where the module description comprises a self-contained data element associated with a particular object (or class of objects). In an example, a module description may comprise a number of data files in a zip folder which further comprises an XML description which provides a wrapper for the files and identifies the type of data stored in each of the data files. For example, a module description may comprise: a 3D model, a list of software libraries, a set of hardware parameters, a set of rules and a list of object variables.

The instantiation-specific data store 108 stores data which is specific to a device being developed using the IDE, including inferred parameters (which are generated by one of the views and include details of the objects which have been selected to form part of the prototype) and global parameters (which may be specified by a user). Details of the 3D configuration and the software that has been written to run on the prototype may also be stored within this data store 108 or may be stored elsewhere (e.g. on a local disk, on a file share or in a version control repository/database). Examples of global parameters (which may also be referred to as global constraints) may include: a maximum dimension (e.g. thickness) of the prototype, the required battery life, the fact that a fan is not to be used (which may affect the components which are available for selection by a user, e.g. by limiting the available processors to those processors which produce small amounts of heat) etc. Although the global parameters are described as being input via the physical design view, it will be appreciated that the global parameters may alternatively be input via another view or dedicated view may be provided for inputting such global parameters.

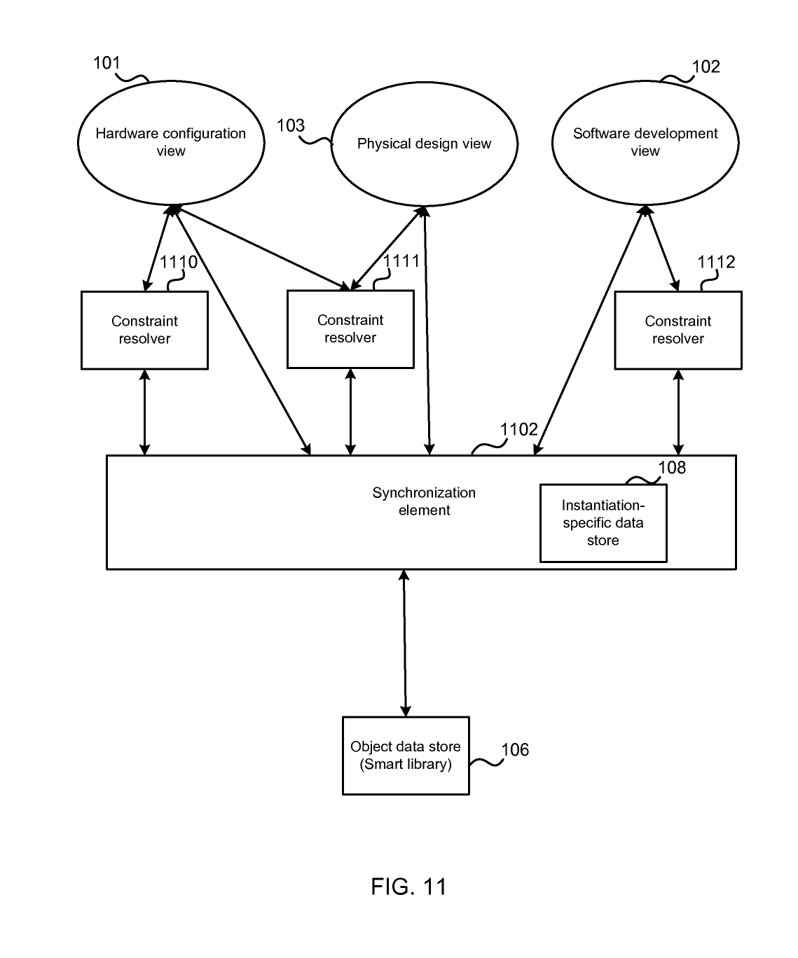

The instantiation-specific data store 108 may support versioning, such that different versions of the software and/or hardware configuration for a particular project can be stored. This may enable a user to revert back to a previous version, for example where an update (e.g. changing or adding hardware, rearranging components in space and/or amending code) causes a problem. As described above, the two libraries: the object data store 106 and the instantiation-specific data store 108 each store data which is relevant to each of the views within the IDE and in the arrangement shown in FIG. 1, each store can be accessed by each view. In other arrangements, the data from one/both stores 106, 108 may be available to each view via another element, such as a central repository (e.g. as shown in FIGS. 9 and 11).

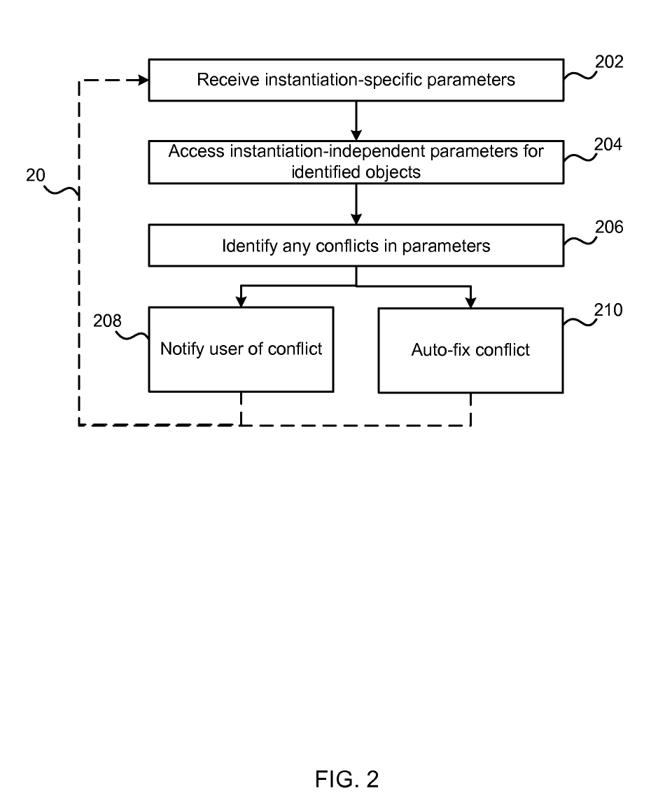

The constraint resolver 104 checks that parameters do not clash, where these parameters may include some or all of: parameters inferred by views; user-specified parameters (which are instantiation-specific and stored in the instantiation-specific data store 108); and instantiation-independent parameters, e.g. parameters associated with particular objects which have been selected, which are stored in the object data store 106. FIG. 2 shows a flow diagram of an example method of operation of the constraint resolver 104. The constraint resolver 104 receives instantiation-specific parameters (block 202), which includes details of the particular objects (or classes of object) that form part of a device design. Based on these parameters, the constraint resolver also accesses instantiation-independent parameters for the particular objects from the object data store (block 204). The instantiation-independent parameters may include details of the constraints/rules associated with selected objects. The instantiation-specific parameters may be received from the data store (in block 202) in response to periodic requests sent by the constraint resolver to the instantiation-specific data store, alternatively, the instantiation-specific data store or one of the views 101-103 may push these parameters to the constraint resolver when they are generated or updated or upon a change in views (e.g. as initiated by a user). The monitoring by the constraint resolver 104 may be periodic (as in the example described) or the monitoring may be continuous.

Having received/accessed the parameters associated with a device design (at the particular stage in the design which has been reached and where the device design may not be complete), the constraint resolver determines if there is a conflict between any of the parameters (block 206) and if there is a conflict, the constraint resolver may flag the conflict to the user (block 208), e.g. via the graphical user interface (GUI) of the IDE, or alternatively, the constraint resolver may attempt to automatically fix the conflict (block 210). In an example, the conflict may be determined by comparison of parameter values and in another example, the rules associated with an object may be used. In a further example, the parameters associated with multiple objects may be combined (e.g. summing the power consumption for each object within a device and then comparing this to a maximum power consumption for the device which may be specified as a global parameter). The process is repeated (e.g. periodically or in response to receiving new instantiation-specific parameters, as described above), as indicated by dotted arrows 20. Where a conflict is notified to a user via the GUI, a special GUI screen may be used or alternatively one of the views may be used. In an example, where the objects selected cannot fit within a user-specified maximum dimension for the prototype, this may be displayed graphically in the physical design view (e.g. by highlighting the portions of the prototype which extend beyond the boundary set by the user-specified parameter). In another example, the conflict resolver may receive an inferred parameter of the power consumption of the device when executing code written in the software development view. The constraint resolver may access data for the selected battery object and identify that the power provided by that battery is insufficient. In this case, the IDE alerts the user of the conflict.

The method of automatically resolving the conflict (in block 210) which is used may dependent on the particular objects or classes of object which have been selected and configured within the prototype design. In an example, where a class of object ‘memory’ has been selected (e.g. via the hardware configuration view) and the software development view generates an inferred parameter of the required amount of memory to store the code, if the class of object includes memory elements which are not sufficiently small, the conflict may be resolved by updating the object selection to specify memory elements which are sufficiently large or by selecting a particular memory element which is large enough to satisfy the inferred parameter. This selection of a different object (or a subset of a class of object) may be performed by the conflict resolver itself or alternatively, the conflict resolver may trigger one of the views to run automatic decision-making algorithms to make this determination. In this particular example of a conflict in relation to memory size, the conflict resolver may trigger (in block 210) the hardware configuration view 101 to select an appropriate memory element to address the conflict in parameters. If this resolution is not possible, the IDE may flag an error to the user (as described above). In some situations, it may be possible to attempt conflict resolution in another view (e.g. where the conflicting parameters are affected by multiple aspects of the design).

The use of the constraint resolver 104 and, in some examples, the generation of inferred parameters by views of the IDE (which may be stored in the instantiation-specific data store 108) enables access to pertinent design requirements to be shared between views within the IDE. The constraint resolver and data stores provide a framework whereby design decisions selected by the user in one view cause the available options/operations in other views to reflect these possibilities. This has the effect of extending intelligence across previously unlinked aspects of device design.

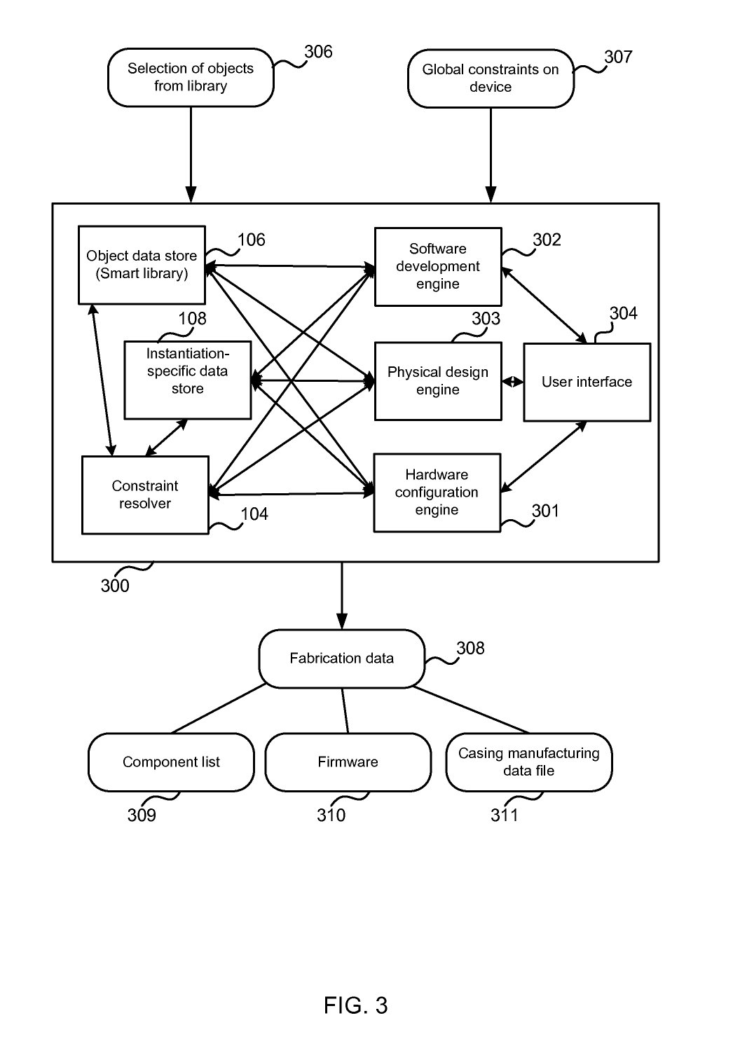

FIG. 3 is a schematic diagram showing an alternative representation of the IDE shown in FIG. 1. The IDE 300 comprises the object data store 106, instantiation-specific data store 108 and constraint resolver 104, as described above. The IDE also comprises a number of engines 301-303 which provide the computation behind the views 101-103 shown in FIG. 1. In this example, the hardware configuration engine 301 is associated with the hardware configuration view 101, the software development engine 302 is associated with the software development view 102 and the physical design engine 303 is associated with the physical design view 103. Although in this example there is a 1:1 relationship between engines and views, this is by way of example only and in other embodiments, a single engine may be associated with multiple views and vice versa.

The IDE further comprises a user interface 304 which provides the GUI which is displayed to the user and through which the user interacts with the views 101-103 (and hence engines 301-303) to design a device (e.g. a prototype). As described above, the user interface allows a user to easily switch between different views (which may also be referred to as representations), each view providing tools that allow different representations of the data to be edited (e.g. a code editor, a sensor input stream/interaction editor and a 3D design editor). It will be appreciated that there are many different interaction possibilities for moving between views, such as double clicking, right clicking, Alt-Tab and Ctrl-Tab.

The arrows in FIG. 3 show examples of the data paths between elements in the IDE, however, it will be appreciated that this is by way of example only and data may flow in different routes/directions and between different elements than those shown in FIG. 3.

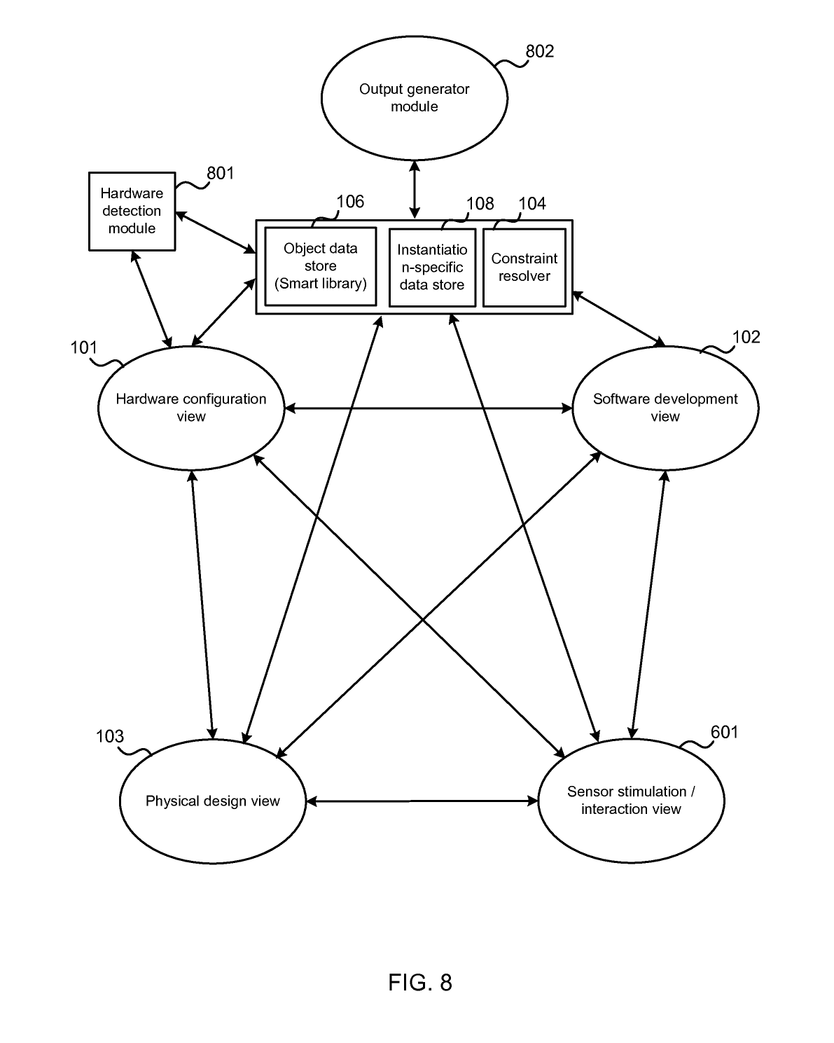

FIG. 3 also shows a number of inputs and outputs 306-308 of the IDE 300. As described above in relation to FIG. 1, the inputs to the IDE include a user's selection of objects 306 and any global constraints on the device 307. Dependent upon the particular implementation, the global parameters may be specified through any of the views within the IDE or a specific part of the GUI may be provided to enable a user to specify the global parameters. In an example, the global parameters may be imported from an external source. The output from the IDE comprises fabrication data 308 to enable the device to be built. This fabrication data may, for example, comprise one or more of: a component list 309, firmware 310 and a data file 311 which can be used to manufacture a case for the device. In some embodiments, the firmware may be output directly to the processor and in other embodiments the firmware may be output such that a user can load it onto a processor. In some examples, a user may be guided through the build process by an output generator module. The fabrication data and the output generator module is described in more detail below with reference to FIG. 8.

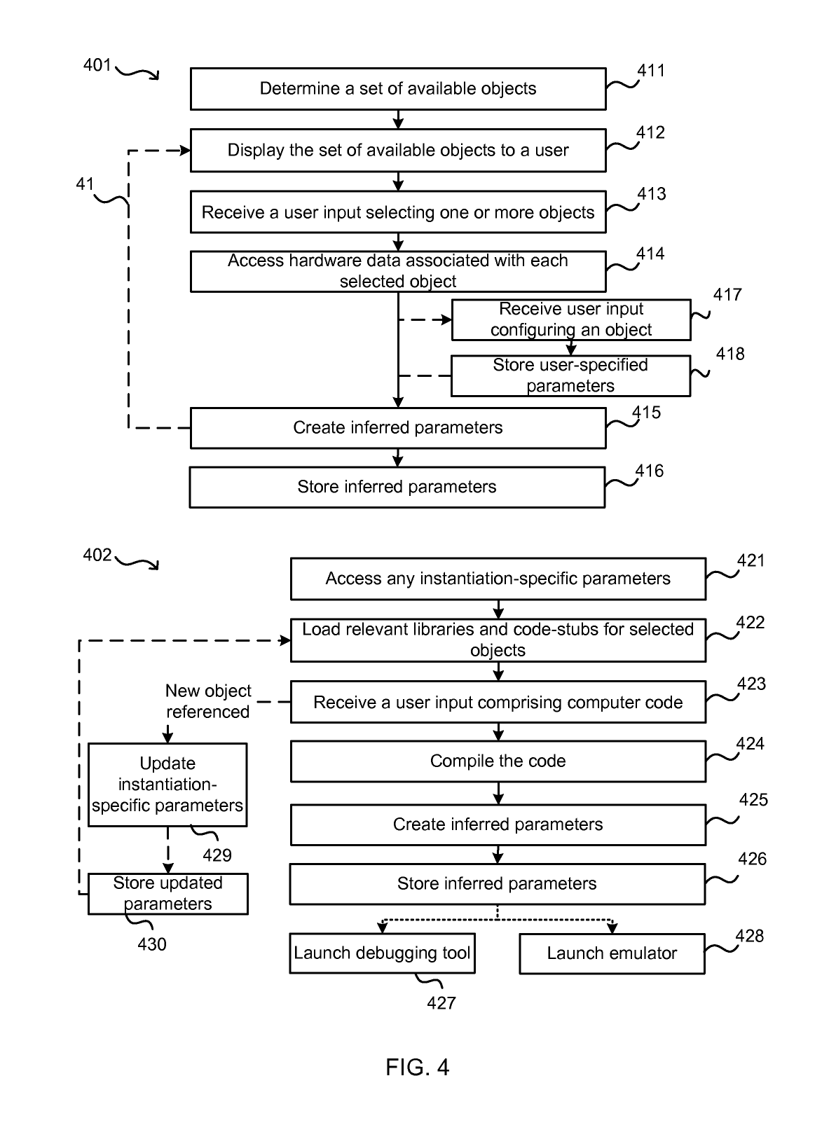

FIG. 4 comprises two flow diagrams 401-402 which show example methods of operation of the hardware configuration engine 301 and the software development engine 302 respectively. The first flow diagram 401 shows an example method of operation of the hardware configuration engine 301. The method comprises determining the set of available objects (or classes of object) based on any instantiation-specific parameters (block 411) and this may involve accessing parameters stored in the data store 108. The set of available objects are then displayed to a user (block 412) to enable them to make a selection. The engine receives a user input selecting one or more objects (block 413) and then accesses the hardware related data for each object from the object data store 106 (block 414). The engine may also receive a user input configuring an object (block 417) and this configuration may be enabled following receipt of the hardware related data (in block 414). The configuration data results in user-specified parameters which are stored in the instantiation-specific data store 108 (block 418). Based on the selected objects, hardware data and any configuration data, the engine computes any inferred parameters (block 415) and stores them in the parameter store (block 416). Having selected an object (block 413) and/or created inferred parameters (in block 415), this may affect the set of available objects that the user can continue to select and therefore aspects of the method may be repeated (as indicated by dotted arrow 41).

Examples of inferred parameters which may be generated by the hardware configuration engine 301 include: the time for the device to fully wake from sleep (e.g. based on the wake times for the objects which make up the device), the estimated remaining capacity of any shared buses (e.g. I2C) within the device (e.g. if a video module and another sensor both used the bus then the stated data rates might exceed the known capacity of the bus), the particular way an object is connected to another object (e.g. where more than one option is available), etc.

The second flow diagram 402 in FIG. 4 shows an example method of operation of the software development engine 302. The method comprises accessing any instantiation-specific parameters in the data store 108 (block 421) and if any objects have already been selected (e.g. in the hardware configuration view), loading the relevant libraries and the code-stubs which are used to interface with the particular objects (block 422). The libraries and code-stubs, or references to them, are stored in the object data store 106 associated with the particular object. Other data relating to selected objects may also be accessed from the object data store 106 and an example of such data may be the orientation sensitivity of an object (e.g. an accelerometer or any directional sensor) and how this should be corrected for in software, based on an inferred parameter of the actual orientation of the object within the device (as generated by the physical design view 103). User input may be received which defines code (block 423) which may be compiled (block 424) upon receipt of a request from the user (e.g. the user may click a ‘compile’ button within the GUI of the software development view 302). If the code written by the user (as received in block 423) includes a reference to a new object that has not previously been selected (as determined based on the instantiation-specific parameters accessed in block 421), the software development engine 302 updates the instantiation-specific parameters to include selection of the new object (block 429), stores the updated parameters in the data store 108 (block 430) and loads any additional libraries and code-stubs that are required (block 422).

On compilation (in block 424), the software development engine creates inferred parameters (block 425) and stores these in the instantiation-specific data store 108 (block 426). As described above, an example of an inferred parameter which may be generated by the software development engine is the amount of memory required to store the code or the amount of memory required to execute the code. The inferred parameters generated may depend on activity within the particular engine and also on other instantiation-specific and/or instantiation-independent parameters. For example, an inferred parameter of the estimated battery life of the prototype may be generated based upon the selected battery object, instantiation-independent parameters for that object and the code written.

The method may also comprise launching a debugging tool (block 427) and/or an emulator (block 428). As with the compilation step (block 424), the debugging tool and/or emulator may be launched (in blocks 427 and 428) in response to a user request (e.g. by clicking on a ‘debug’ or ‘emulator’ button within the GUI).

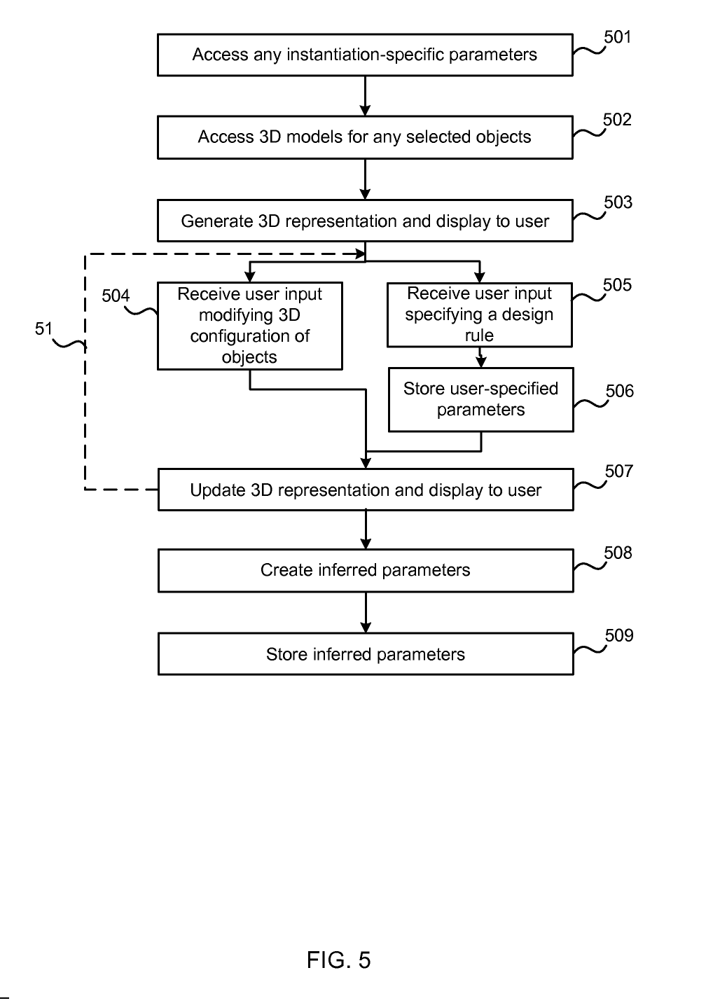

FIG. 5 is a flow diagram showing an example method of operation of the physical design engine 303. The physical design engine 303 accesses any instantiation-specific parameters stored in the instantiation-specific data store 108 (block 501), in particular, the physical design engine accesses details of the objects which have been selected to form part of the device. The 3D model (or a reference to a 3D model) for each selected object is then accessed from the object data store 106 (block 502) and used to generate and display a 3D representation of the device (block 503). A user can interact with the engine 303 by providing a user input which manipulates the 3D model (received in block 504) and/or by specifying design rules (which may also be global parameters) associated with the device (received in block 505). An example of such a user input would be one that specifies a maximum thickness for the device or the required position for a display. Where a user input is received which specifies a design rule (or global parameter), these user-specified parameters are stored in the instantiation-specific data store 108 (block 506). As a result of any user input (in block 504 or 505), the 3D model may be updated and the updated model displayed to the user (block 507) and this process may be repeated for multiple successive inputs (as indicated by the dotted arrow 51). The physical design engine 303 creates inferred parameters (block 508) based on the resulting 3D model and stores them in the instantiation-specific data store (block 509). An example of an inferred parameter which may be generated by the physical design engine is a dimension of the device.

FIG. 6 is a schematic diagram of another IDE for rapid development of devices. The IDE shown in FIG. 6 comprises an additional view, a sensor stimulation/interaction view 601, in addition to the elements shown in FIG. 1 and described above. As with the IDE described above, a user may select these views in any order when developing a device and may switch between views when they choose and as such the IDE shown in FIG. 6 also provides a flexible non-linear approach to device design. As in FIG. 1, the views 101-103, 601 are linked by a constraint resolver 104 which provides synchronization between views such that a change made to a design by a user in one view is reflected in the other views.

The sensor stimulation/interaction view 601 allows a user to access sensor data which is stored in the object data store 106 (e.g. associated with a particular object which forms part of the device) and to simulate operation of the device in response to the sensor data or to combinations of sensor data (e.g. multiple streams which exercise different parts of the device substantially simultaneously). Details of the performance of the device can be displayed to the user and the user may be able to specify the parameters which are to be monitored during the simulation. The view collects performance data while the simulation runs and this may be displayed to the user in real time or after the simulation has finished. There are a number of other operations that the view may enable a user to do, such as designing sensor streams, simulating response to user interactions, specifying test cases, interacting with the device and recording interactions and these are described in more detail below.

Examples of sensor data which may be used in the simulation may comprise:
GPS information—either at a high level or low level pre-recorded sequences
Accelerometer data—including the possibility of using a proxy accelerometer to record and then play back such data as virtual sensor data for the actual designed device
Button presses, touches etc
Temperature
Radio packet communications etc
Bluetooth, WiFi or Zigbee communications

In addition to (or instead of) simulating the performance of a device in response to a sensor data accessed from the object data store, the performance may be simulated in response to a user interaction or a sequence of interactions. In an example, the view may provide a user with a virtual interface to the device (e.g. a graphical representation of a prototype mobile phone where the user can click on buttons to simulate operation of the mobile phone) such that the user can interact with a virtual device. In another example, a user may be able to interact with actual hardware objects connected to the system. In either situation, the interaction sequence may be recorded by the IDE so that it can then be used for simulation or the simulation may run in real time as the interactions occur. The recorded interaction sequence data may be stored in the data store such that it can be used for future testing of the particular device, if required. In some examples, the data may be instantiation-independent and may be stored in the object data store 106.

The view may enable a user to design sensor streams and/or test cases for use in simulation/testing of the device. A sensor stream comprises details of inputs received by the device (which may include interaction sequences) and/or conditions experienced by the device (e.g. environmental conditions) and the test cases comprise sensor streams and details of the performance (or outputs) of the device that are expected in response to the sensor streams. For example, if a multi-touch capable touchscreen device is expected to be able to detect a finger tip of a particular size and to distinguish between touches which are separated by a defined minimum distance, a test case may be developed which specifies a set of touch events and defines the expected detected signals. Design of test cases may be by manual input of data/numbers/vectors or using utilities/tools which generate (for example) special waveforms or by using real-time manual proxy stimuli. When running a test case, the view compares results to the defined outputs and can flag any differences to the user via the GUI.

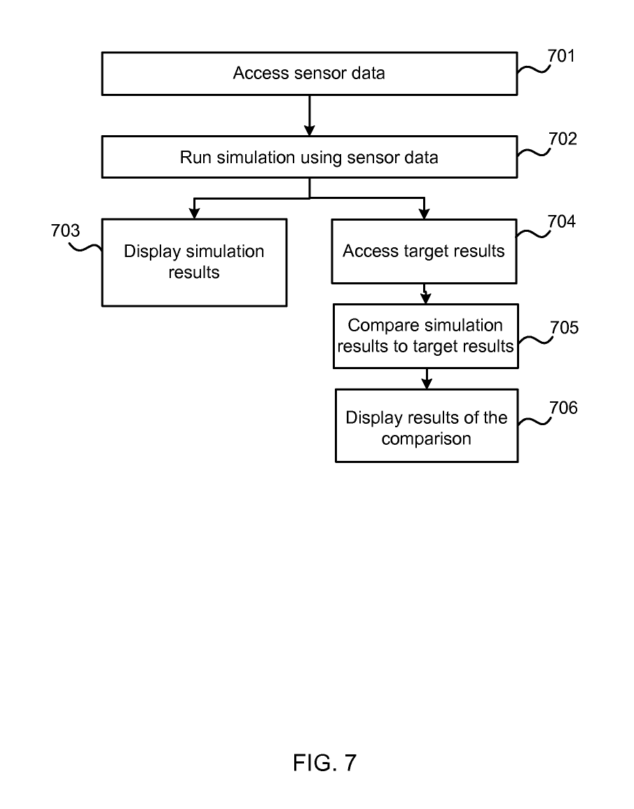

The IDE may comprise a simulation engine which is associated with the sensor stimulation/interaction view 601. FIG. 7 shows a flow diagram of an example method of operation of the simulation engine. The simulation engine accesses sensor data (block 701) and as described above, there may be many different sources for this sensor data. It may be read from the object data store 106, recorded while a user interacts with real or virtual hardware or user specified (and received by means of a user input). The data is then used in running a simulation of the device (block 702). In running the simulation, the simulation engine uses data stored in the object data store 106 relating to the particular objects which make up the device and instantiation-specific data from the instantiation-specific data store 108. The simulation results may then be displayed to the user (block 703) or in another example, the results may be compared to the required results (where these results are accessed in block 704 and the comparison performed in block 705). Results of the comparison may then be displayed to the user (block 706) and in some instances these results may simply denote a pass or fail against the defined tests.

Where a prototype does not satisfy a test case (e.g. it does not give the required output in response to an input) this may be fed back to the constraint resolver 104, either directly or by way of an inferred parameter generated by the sensor stimulation/interaction view 601 and stored in the parameter store 108. The constraint resolver 104 may then attempt to resolve this in a similar manner to a conflict between parameters described above.

The sensor stimulation/interaction view may be considered as providing a test environment for the device. By providing a test environment in which sensor-rich devices being designed can be “exercised” at the design stage many issues which would otherwise not become obvious may be highlighted. A first example might be that some external sequence of sensor stimuli enables power consumption performance of the device to be measured more accurately. A second example is where certain asynchronous sequences of external sensor interrupts can cause device lockup or poor performance/unresponsiveness in the user interface, for example an accelerometer which provides sample interrupts to the main processor at certain acceleration thresholds might be found to drain batteries too quickly with certain accelerations over time due to simulated motion inputs.

Like the other views 101-103, the sensor stimulation/interaction view 601 may generate inferred parameters and store them in the data store 108. Examples of inferred parameters which may be generated by the sensor stimulation/interaction view include performance parameters such as power consumption or responses to particular stimuli.

FIG. 8 is a schematic diagram of a further IDE for rapid development of devices. Compared to FIG. 6, the IDE shown in FIG. 8 comprises two additional elements: a hardware detection module 801 and an output generator module 802. It will be appreciated that an IDE may comprise either one of these additional elements and an IDE may comprise one or both of these additional elements and not a sensor stimulation/interaction view 601. These two additional elements are described in more detail below.

The hardware detection module 801 allows a user to build a device within the IDE by connecting together actual hardware objects, such as the modular hardware elements described above. When a user connects at least one of the actual hardware objects, such as the core module from the set of modular hardware elements, to the hardware detection module 801, (e.g. via USB), the module automatically detects which modules are connected and updates the hardware configuration view 101. This detection process may use data stored in the object data store 106, for example, where a particular module has a defined address and the hardware detection module 801 detects the address, the object data store 106 may be used to search for the module which corresponds to the detected address. On receipt of data identifying connected modules, the hardware configuration view 101 in updates the instantiation-specific parameters and generates inferred parameters (as described above). Alternatively, the hardware detection module 801 may update the instantiation-specific parameters and store these directly in the instantiation-specific data store 108.

Instead of (or in addition to) detecting the presence of hardware objects via an electrical connection, the hardware detection module 801 may use a camera (e.g. a webcam) to identify a collection of hardware objects. In such an instance, the object data store 106 may store a representative image associated with each object (or class of objects) and the hardware detection module 801 may use image analysis algorithms to identify elements within a captured image (or sequence of images) and to search the object data store 106 for matching (or similar) images.

In some embodiments, a user may be able to use the hardware detection module 801 to detect and store a first set of objects and then subsequently to detect a second set of objects such that the device comprises the combination of both sets of objects. This may be useful for complex devices where it is not possible to fit all the objects within the field of view of the camera or where it is not possible to connect all of the objects to the core module (e.g. due to limitations in numbers of connectors or in lengths of connecting leads).

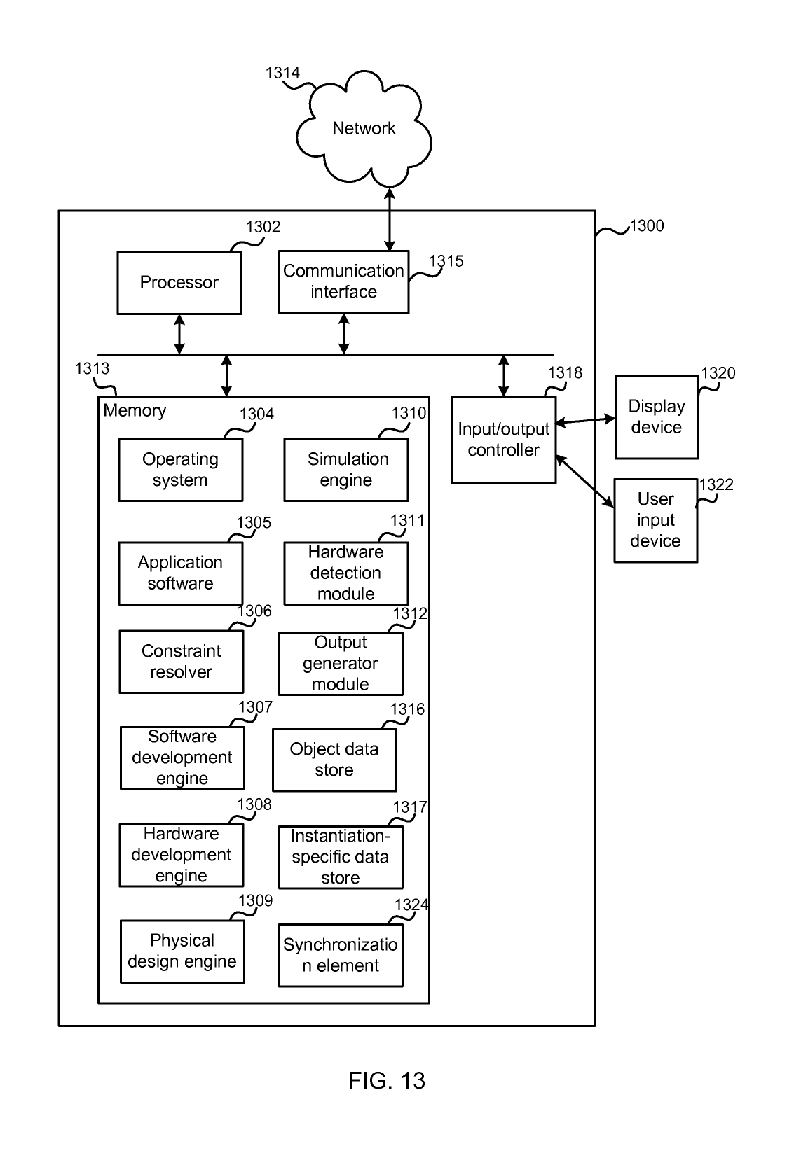

The output generator module 802 generates the data 308 which is used in fabricating the device and in some examples may guide the user through the build/output process (e.g. using a series of prompts and/or questions). As described above with reference to FIG. 3, the data which is output may comprise one or more of: a component list 309, firmware 310 and a data file 311 which can be used to manufacture a case for the prototype. In an example, the output generator module 802 allows a user to specify the manufacturing technique which is to be used for the prototype casing (e.g. laser cutting or 3D printing) and the selected technique affects the format of the data file 311. In an example, the manufacturing technique may be selected from a number of options displayed to the user by the output generator module 802 and where the user selects laser cutting as the method, the output generator module 802 flattens the design of the case (which was automatically generated by the physical design engine 303) into sides that can be slotted and glued together and produces an output file which is suitable for inputting to a laser cutter. In some embodiments, the output file may be output to the laser cutter or other fabrication equipment (e.g. 3D printer), e.g. directly or via a network connection (such as communication interface 1315 shown in FIG. 13).

The output generator module 802 additionally compiles the software code (if this has not been compiled already) and produces the firmware which will run on the processor(s) within the device. In some examples, the processors may be programmed directly by the output generator module 802 if a user connects them via USB to the IDE (and the user may be prompted to do this). In other examples, or for secondary processors, the output generator module 802 may output a firmware file which can be loaded onto a processor (e.g. using a third-party tool). Where multiple devices are being made, the output generator module 802 may program multiple processors in parallel or may program them sequentially, prompting the user to disconnect one processor module and connect another one after completing each iteration.

In an example, the output generator module 802 may, in response to receiving a ‘print n’ user input (where n is the number of devices that are required), cause firmware programmers to be launched n times, the manufacturing equipment (e.g. laser cutter or 3D printer) to produce n physical designs (e.g. n copies of the device casing), automatic stock count of required parts, automatic co-labeling of hardware and software so that the physical case label and the software version/serial number label are synchronized etc.

In addition to generating the data 308 which is used in fabricating the device and outputting this data, the output generator module 802 may also generate a ‘project archive’ output which includes details of any stored versions, test results and other data relating to a particular project to develop a device. This archive data may then be stored externally to the IDE in case it is needed in the future.

The methods described herein can dramatically reduce the length of time taken to produce a device (e.g. a prototype device). In an embodiment where modular hardware is used (as described above) and the output generator module 802 outputs a data file for production of a case using rapid techniques such as laser cutting or 3D printing, it is possible to go from an initial idea to generating a number of prototypes (e.g. five) in just 8 hours. Additionally, the prototypes are considerably more robust and refined than would normally be the case for a first generation prototype. This has the effect that the number of iterations that are required is reduced which reduces overall timescales between concept and final design and also reduces the project cost.

FIG. 9 shows a schematic diagram of a further example IDE for rapid development of devices. In this example, the IDE comprises a synchronization element 902 which maintains a working data set for the current build status of the device being developed. This data set includes both instantiation-independent and instantiation-specific data and consequently the synchronization element 902 can be considered to comprise the instantiation-specific data store 108 (as shown in FIG. 9). The synchronization element 902 further comprises a constraint resolver 104.

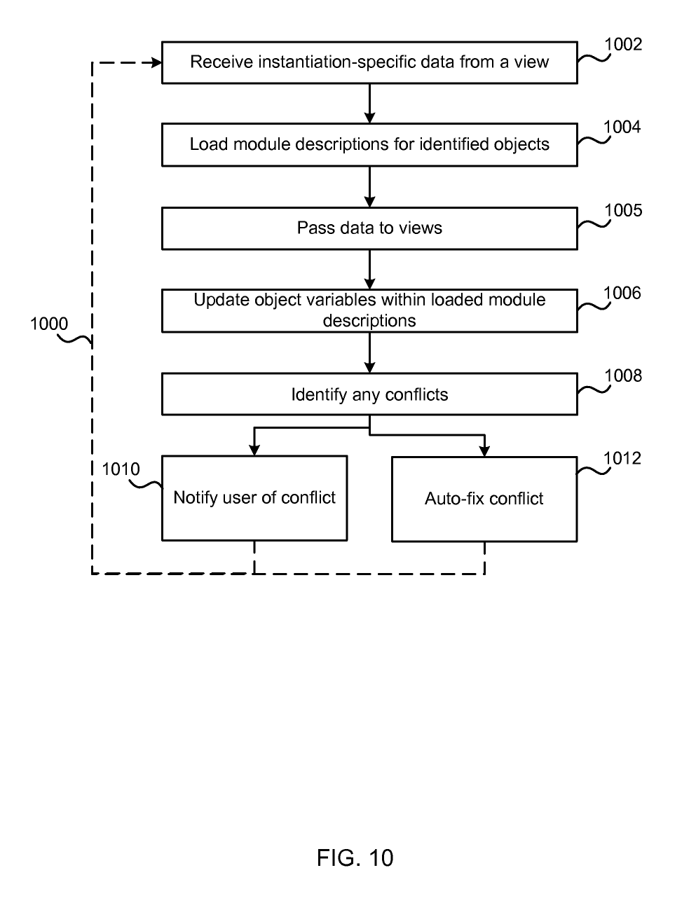

FIG. 10 is a flow diagram of an example method of operation of the synchronization element 902. The synchronization element 902 receives instantiation-specific data from one or more of the views 101-103 (block 1002). The instantiation-specific data may be received from a view (in block 1002) in response to a user-selection within a view (which may select a new object or result in the generation or updating of an inferred parameter) or upon a change in views (e.g. as initiated by a user). The data received includes details of the particular objects (or classes of object) that form part of a device design and may also include other inferred parameters generated by a view.

The synchronization element 902 maintains a representation of the device being developed and therefore loads the module descriptions for each identified object, or class of objects (block 1004). The synchronization element 902 may comprise a library manager 904 which selects the particular module descriptions to load from the object data store 106. Data relating to the device representation maintained by the synchronization element is passed to the views as required (block 1005) and this may be performed multiple times at any point in the flow diagram shown in FIG. 10. The synchronization element 902 may comprise a system manager 906 which performs the pushing of constraints back up to each view based on the module descriptions within the working data set. The data provided to a view may comprise instantiation-independent and/or instantiation-specific data.

In an example, the library manager 904 may initially pull in generic module descriptions, e.g. module descriptions for classes or sub-classes of objects and gradually, as the choice of objects within a device is narrowed down, more specific module descriptions may be loaded into the working data set.

As described above, a module description for an object may include details of one or more ‘object variables’ which may have instantiation-specific values. As data is received from views (in block 1002), the values of these variables is updated by the synchronization element (block 1006). The value of an object variable may be generated as an inferred parameter within one of the views or the value may be computed by the synchronization element based on one or more inferred parameters and/or rules also contained within the module description. Values of one or more object variables may be passed to views in block 1005.

In maintaining a representation of the device being developed, the synchronization element uses any rules stored in the module description for identified objects. These rules may, for example, provide a linking between views, e.g. by providing a rule which maps hardware configuration (e.g. which sockets are connected) to which methods are enabled in the software code. In a practical example, an object which is an SD card reader may have a rule which specifies that if one wire is connected then the read and write methods are enabled, but if two wires are connected, the method to check if the card is present or not and the method to determine if the card is write protected are also enabled. In another example, the synchronization element 902 may use a rule to convert an object variable into a parameter understood by a view or to perform translation of other parameters.

In this example, the synchronization element 902 comprises a constraint resolver 104 and having loaded module descriptions (block 1004) and updated object variables, if required, (in block 1006), the synchronization element determines if there is a conflict between any of the parameters/variables (block 1008) and if there is a conflict, may flag the conflict to the user (block 1010), e.g. via the GUI of the IDE, or alternatively, may attempt to automatically fix the conflict (block 1012).

The process shown in FIG. 10 may be repeated (e.g. periodically or in response to receiving new instantiation-specific parameters, as described above), as indicated by dotted arrows 1000 and it will be appreciated that the blocks may be performed in different orders, e.g. data may be passed to/from views at any time or substantially continuously.

In an example of a constraint resolution operation performed by the synchronization element 902, each of the three different views may identify a different subset of objects within a class (e.g. different objects within the class of cameras) which satisfy the criteria associated with the view. The different subsets are based on the view specific criteria applied in each view, e.g. size in the physical design view 103 and resolution in the hardware configuration view 101. The synchronization element 902 identifies from the data received from each view, which camera(s) are included in all three subsets and are therefore suitable for use in the device.

Where an object is subsequently removed from the device being developed, the relevant data (e.g. the relevant module description) may be deleted from the representation stored within the synchronization element 902. However, in some examples, the data may not be deleted but instead flagged as disabled such that should the object be reselected as forming part of the device, it is not necessary to reload the module description and reset any object variables which may already have been specified for the object. This may be particularly useful in situations where an object is accidentally removed or disconnected (e.g. in an example which includes a hardware detection module 801).

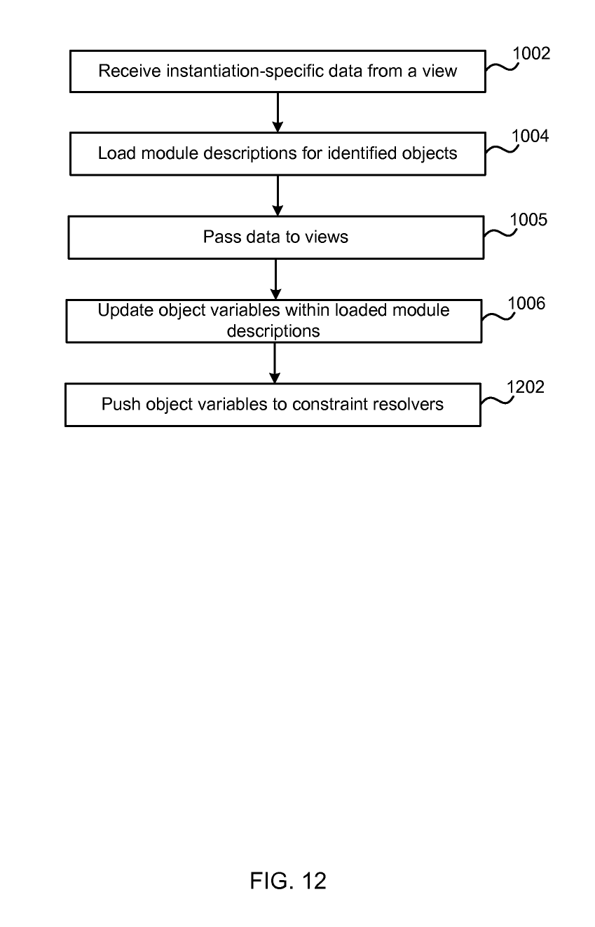

FIG. 11 shows a schematic diagram of another example IDE for rapid development of devices. This example comprises a synchronization element 1102 and one or more constraint resolvers 1110-1112. These constraint resolvers may be specific to a particular view (e.g. constraint resolvers 1110, 1112) or may be shared between two or more views (e.g. constraint resolver 1111). Each constraint resolver may understand a subset of the object variables and rules associated with the objects which make up a device and in such an example the synchronization element pushes the relevant object variables and any other relevant parameters/rules (e.g. as extracted from the loaded module descriptions) to each constraint resolver. This is shown in block 1202 of FIG. 12, which comprises a flow diagram of another example method of operation of a synchronization element. The individual constraint resolvers 1110-1112 can then identify conflicts and either notify the user of the conflict or automatically resolve the conflict (in a similar manner to that shown in blocks 206-210 in FIG. 2).

Although FIG. 12 shows data being passed both to views (in block 1005) and to the constraint resolvers (in block 1202), in other examples, data may be passed from the synchronization element 1102 to either a view or to an associated constraint resolver and data may then pass between the view and the associated constraint resolver as required. Furthermore, although FIG. 12 does not show a library manager 904 or system manager 906, it will be appreciated that the synchronization element 1102 may comprise one or both of these elements.

In some examples, the synchronization element 902, 1102 may use rules within the loaded module descriptions to translate variables or parameters such that they can be interpreted by different views. The variables or parameters being translated may be object variables and/or inferred parameters generated in a view. In an example, the synchronization element may translate between object variables associated with selected objects and parameters which are understood by a particular view or constraint resolver. In such an example, the data pushed to a view (in block 1005) or constraint resolver (in block 1202) may comprise one or more translated variables in addition to or instead of actual object variable values and/or other parameters. In a practical example of a translation which may be performed by the synchronization element, the element may receive a view specific parameter of ‘Card Detect API Used’ from the software development view 102 and translate this to a general parameter or to another view specific parameter of ‘CD Wire True’ which is understood by the hardware configuration view 101.

In the examples described above, a single level of constraint resolution is provided, either a central constraint resolver (e.g. as shown in FIGS. 1 and 9) or multiple constraint resolvers in parallel (e.g. as shown in FIG. 11). In a further example of an IDE, multiple tiers of constraint resolvers may be provided. For example, view-specific constraint resolvers 1110-1112 (as shown in FIG. 11), which are linked to one or more views, may be provided in addition to a central constraint resolving capability within the synchronization element (as shown in FIG. 9). In such an example, the synchronization element may provide high level constraint resolution and/or resolution of constraints which cut across all (or many) of the views. An example of such a constraint is a thermal constraint, as this is affected by the objects selected, the positioning of those objects and the code which is run on the objects. In such an example, the individual constraint resolvers 1110-1112 associated with views may provide more detailed view-related constraint resolution (e.g. a physical constraint resolver which identifies where objects overlap in the 3D space and a hardware constraint resolver which identifies object incompatibilities, insufficient bus capacity, etc). In further examples, there may be more than two levels of constraint resolution.

Although FIGS. 9 and 11 only show three views and do not include a hardware detection module or output generator module, it will be appreciated that further example IDEs may comprise additional views and/or additional modules (e.g. one or both of the additional modules shown in FIG. 8).

The following paragraphs provide an example scenario of designing a new mobile phone which demonstrates how an IDE such as those described above may be used to improve the process of producing prototypes which allows a single user to rapidly view and develop all aspects of a design in a unified and efficient manner.

In the example scenario, a user might start by launching the application, creating a new project and loading the software development view, which, as described above, includes support for writing computer code, a front-end to a compiler, access to debugging tools and an emulator. The user can use this view to write the basis for the software code that will run on the device. On compiling the software, they find that the code will require 8 Mb of storage and 4 Mb of memory to execute.

By switching to a hardware configuration view on the application, the user is able to select from a list of multiple memory and processor options available, and choose one that fulfils the software's requirements to execute as desired. In addition, they can select and configure number of additional electronic modules necessary for the phone to work: namely a display of a certain size and resolution, GPRS module, a battery, and keypad for user input.

By switching to the physical design view, the user can see accurate 3D representations of all the individual electronic modules they have selected. They can interact with them, lay them out with respect to each other and get an initial impression of the size and shape that this configuration will require. The user specifies a maximum thickness for the phone and this causes the display module to be highlighted since it is too thick to fit. On returning to the hardware configuration view, the user chooses an alternative display module which is thinner, with this view automatically “graying out” hardware options that would violate the physical thickness constraint.

By switching to a sensor simulation/interaction view, the user can design sensor input streams with which to exercise the different peripheral sensors which may be included in the design either with prepared sensor input streams or (as with the interaction techniques mentioned in the physical design view above) by allowing simulated interaction in real time with the input and output modules included in the design. Certain sensors may have libraries of standard stimuli with which to attach to each included sensor (such as a temperature gradient over time for a temperature sensor).

Switching back to the software development view, the user finds that the application has already loaded all necessary libraries, included the relevant references and added the appropriate code-stubs necessary to interface with the additional hardware elements that have been selected.

On compiling the code again, the application gives an estimation of what the battery life of the device will be, given the current hardware configuration and simulated software execution. Given this information, the user switches to the hardware configuration view, selects and deletes the current battery module, and replaces it with a higher capacity battery. Switching to the physical design view, they notice that the new battery is larger, and adjust the relative placement of the 3D modules on the screen to accommodate it in their design.

During the process of coding, the user adds a reference to a new type of hardware module that has not previously been configured—a camera with photo and video recording capabilities. When the reference to the camera is added in software development view, it is also automatically loaded selected in the hardware configuration and physical design views. The user is able to rearrange the existing 3D representations to accommodate the camera in the desired position, and then switch to the hardware configuration view to configure the new module and specify its image-capture resolution.

The user switches again to the physical design view, and selects an option to ‘Automatically Generate Casing.’ Given the relative placement of the constituent 3D representations, the software generates a simple casing to encapsulate them, taking into account mounting and assembly fixtures. The user can make final adjustments, correct placement or make final changes to the design.

At any stage the user has the option to switch to the sensor simulation/interaction view and attach a number of different sensor input stimuli patterns or even directly manipulate the sensor modules through a proxy or virtual interface enabling the software simulation to be interacted with directly in real time—perhaps collecting performance data along the way.

Finally, the user clicks “Print”. This starts a tool that allows the user to make initial prototypes. The user chooses to make 5, and is guided through the software side (compiling and producing firmware for the main processor and secondary processor, automatically programming the main processors by USB and providing a firmware file for the user to load into the secondary processor using a third-party tool. For hardware, the user is given a list of components required so they can check stock and order in necessary parts. For the physical construction, the user chooses to make a laser-cut version, so the software “flattens” the case into sides that can be slotted and glued together, and produces an output file and sends it to the laser cutter.

FIG. 13 illustrates various components of an exemplary computing-based device 1300 which may be implemented as any form of a computing and/or electronic device, and in which embodiments of the methods described herein may be implemented.

Computing-based device 1300 comprises one or more processors 1302 which may be microprocessors, controllers or any other suitable type of processors for processing computing executable instructions to control the operation of the device in order to provide the integrated development environment described herein. Platform software comprising an operating system 1304 or any other suitable platform software may be provided at the computing-based device to enable application software 1305-1309 to be executed on the device. The application software comprises a constraint resolver 1306, a software development engine 1307, a hardware development engine 1308 and a physical design engine 1309. The application software may also comprise one or more of: a simulation engine 1310, a hardware detection module 1311, an output generator module 1312 and a synchronization module 1324.

The computer executable instructions may be provided using any computer-readable media, such as memory 1313. The memory is of any suitable type such as random access memory (RAM), a disk storage device of any type such as a magnetic or optical storage device, a hard disk drive, or a CD, DVD or other disc drive. Flash memory, EPROM or EEPROM may also be used. Although the memory is shown within the computing-based device 1300 it will be appreciated that the storage may be distributed or located remotely and accessed via a network 1314 or other communication link (e.g. using communication interface 1315). The memory 1313 may also comprise the object data store 1316 and the instantiation-specific data store 1317.

The computing-based device 1300 also comprises an input/output controller 1318 arranged to output display information to a display device 1320 which may be separate from or integral to the computing-based device 1300. The display information comprises a graphical user interface for the IDE and renders the different views described above. The input/output controller 1318 is also arranged to receive and process input from one or more devices, such as a user input device 1322 (e.g. a mouse or a keyboard). This user input may be used to enable a user to select objects, configure object parameters, modify the 3D arrangement of selected objects, etc. In an embodiment the display device 1320 may also act as the user input device 1322 if it is a touch sensitive display device. The input/output controller 1318 may also receive data from connected hardware such as modular electronic elements or a webcam (e.g. where the hardware detection module 1310 is used). The input/output controller 1318 may also output data to devices other than the display device, e.g. a to connected hardware in order to program processors or to a laser-cutting machine, 3D printer or other machine used to fabricate the prototype case (not shown in FIG. 13).

Although the present examples are described and illustrated herein as being implemented in a system as shown in FIG. 13 with a particular set of views provided by a particular set of engines and where the objects are hardware objects, the system described is provided as an example and not a limitation. As those skilled in the art will appreciate, the present examples are suitable for application in a variety of different types of computing systems and different views and/or engines may be provided. In an example, the functions described herein may be divided differently between views and/or engines and there may not be a one to one relationship between views and engines. Additionally, some or all of objects may not be hardware objects and may instead comprise chemical objects and in such an embodiment, the hardware configuration view/engine may alternatively be referred to as object configuration view/engine.

It will be appreciated that the double ended arrows in FIGS. 1, 3, 6, 8, 9 and 11 identify possible data paths between elements in the IDE; however, it will be appreciated that these are not the only paths possible and that they are shown by way of example only.

The IDEs described above each provide a single development environment which tightly integrates the tasks that are required to produce a prototype device. The IDEs allow a user to design and develop the different aspects: the electronic configuration, the software that the device runs and its physical form factor. By providing a single environment, a user need not be familiar with multiple tools and it enables a specialist in a particular field (e.g. a physical designer) to better understand the constraints of the electronic modules, or vice versa. Where the IDE includes a sensor stimulation/interaction view, (e.g. as shown in FIGS. 6 and 8), the development environment provides facilities to create sensor input streams and interaction simulation in order to exercise the design ahead of actual implementation. Through use of a single environment, the environment is able to provide a single version number which encompasses all aspects of the device design (e.g. software, hardware and physical design). This improves the traceability of device development.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. An integrated development environment for developing a device, the integrated development environment comprising:
a user interface arranged to provide a plurality of different views to a user, wherein each view is associated with a different aspect of device design;
a database arranged to store a plurality of different types of data associated with each of a plurality of objects, the different types of data relating to the different aspects of device design;
an input for receiving a user input signal selecting at least one object from the database to add to a set of objects which form the device; and
a constraint resolver linking the views such that a change in one view affects at least one other view.

2. An integrated development environment according to claim 1, wherein a view is arranged to generate an inferred parameter based on the user input signal and wherein the environment further comprises:
a data store arranged to store instantiation-specific data including inferred parameters; and
wherein the constraint resolver is arranged to link the views by detecting conflicts in parameters stored in at least one of the data store and the database.

3. An integrated development environment according to claim 2, wherein the input is further for receiving a user input signal specifying a global parameter associated with the device, and wherein the instantiation-specific data includes global parameters.

4. An integrated development environment according to claim 2, wherein the constraint resolver is further arranged to notify the user of a detected conflict in parameters.

5. An integrated development environment according to claim 2, wherein the constraint resolver is further arranged to update the set of objects which form the device in order to resolve a detected conflict in parameters.

6. An integrated development environment according to claim 1, wherein the plurality of different views comprises: an object configuration view, a software development view and a physical design view and wherein the plurality of types of data associated with each object comprise: a 3D model of the object; details of any software libraries used by the object; and parameters for the object.

7. An integrated development environment according to claim 6, wherein the object configuration view comprises a hardware configuration view and the parameters for the object comprise hardware parameters.

8. An integrated development environment according to claim 6, wherein the plurality of different views further comprises a simulation view arranged to receive sensor stimulation data and simulate performance of the prototype device in response to the sensor stimulation data.

9. An integrated development environment according to claim 8, wherein the sensor stimulation data comprises at least one of: sensor stimulation data accessed from the database and associated with one of the set of objects which form the device; and user interaction data generated by the simulation view in response to a user interacting with a virtual device.

10. An integrated development environment according to claim 1, further comprising an output for outputting fabrication data.

11. An integrated development environment according to claim 10, wherein the fabrication data comprises at least one of: a component list; firmware to run on the device; and a manufacturing data file for generating a casing for the device.

12. An integrated development environment according to claim 10, further comprising an output generator module arranged to generate the fabrication data based on data associated with each of the set of objects which form the device and based on instantiation-specific data.

13. An integrated development environment according to claim 1, further comprising a hardware detection module arranged to identify one or more objects electrically connected to the integrated development environment and to add the identified objects to the set of objects which form the device.

14. An integrated development environment according to claim 1, further comprising a hardware detection module arranged to capture an image;
identify one or more objects in the image; and add the identified objects to the set of objects which form the prototype device.

15. A method comprising:
storing data associated with a plurality of objects in a database, the data for each object comprising a plurality of different types of data;
enabling a user to select and configure a set of objects from the database to form a device through one of a plurality of different views in a user interface, wherein each view is associated with a different aspect of device design; and
updating information displayed to the user in one view based on a change made by a user in another view.

16. A method according to claim 15, wherein the plurality of different views comprise: an object configuration view, a software development view and a physical design view and wherein the plurality of types of data associated with each object comprise: a 3D model of the object; details of any software libraries used by the object; and parameters for the object.

17. A method according to claim 15, further comprising:
generating at least one inferred parameter in a view based on the selected objects and user inputs received;
storing the inferred parameter in a data store; and
detecting conflicts between any of inferred parameters and parameters for each of the selected objects stored in the database.

18. An integrated development environment comprising:
a user interface arranged to provide a plurality of views to a user, the plurality of views comprising: a hardware configuration view; a software development view; and a physical design view;
an object data arranged to store data relating to a plurality of objects, the data comprising, for each object: a 3D model, related software and hardware parameters;
an input for receiving a user input signal selecting a set of objects from the object data store to form a prototype device;
a constraint resolver arranged to feed a change made in one view into at least one other view; and
an output generator module arranged to generate and output fabrication data for the prototype device based on data in the object data store relating to the set of objects which form the prototype device and instantiation-specific parameters generated in the plurality of views.

19. An integrated development environment according to claim 18, wherein the constraint resolver is arranged to:
receive instantiation-specific parameters;
access data in the object data store relating to the set of objects which form the prototype device;
identify any conflicts in parameters; and
cause details of an identified conflict to be displayed to a user in one of the views.

20. An integrated development environment according to claim 19, wherein the constraint resolver is further arranged to:
cause the set of objects which form the prototype device to be modified to resolve an identified conflict.
